(19) United States
(12) Patent Application Publication
(10) Pub. No.: US 2011/0093612 A1
(43) Pub. Date: Apr. 21, 2011

(54) DEVICE, METHOD AND COMPUTER READABLE MEDIUM FOR BGP ROUTE MONITORING

(75) Inventor: Tetsuya Murakami, San Jose, CA (US)

(73) Assignee: IP Infusion Inc., Sunnyvale, CA (US)

(21) Appl. No.: 12/906,796

(22) Filed: Oct. 18, 2010

Related U.S. Application Data
(60) Provisional application No. 61/252,952, filed on Oct. 19, 2009.

(51) Int. Cl. G06F 15/173

(52) U.S. Cl. 709/238

(57) ABSTRACT

A BGP route monitoring device includes a routing information receiving unit configured to receive BGP routing information. The device also includes a first database storing a plurality of pieces of BGP routing information registered in an IRR server. The server also includes a routing failure detecting unit to classify the received BGP information into states by comparing the received BGP information with the first database and to determine whether the received BGP routing information is an invalid path based on the classified states. In this configuration, the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information matches Origin AS number of the BGP routing information in the first database.

### CROSS-REFERENCE TO RELATED APPLICATION

This application claims priority under 35 U.S.C. §119 from U.S. Provisional Application No. 61/252,952 filed on Oct. 19, 2009. The entire subject matter of the application is incorporated herein by reference.

### BACKGROUND

1. Technical Field

Aspects of the present invention relate to a monitoring device for monitoring BGP routing information, and particularly to a BGB route monitoring device provided with an Anti-Hijack function.

2. Related Art

The internet is formed by connecting a plurality of networks, so-called ASes (Autonomous Systems), which are managed by ISPs (Internet Service Providers). In a router which controls a signal route between ASes, routing information is exchanged through a so-called BGP (Border Gateway Protocol), and a path for transferring data to a destination network is determined based on the exchanged routing information. A router which exchanges the routing information based on BGP is called a BGP router or a BGP speaker. A document, “A Border Gateway Protocol 4 (BGP-4), RFC 4271” describes the details of BGP.

Hereafter, the routing information in the BGP router is frequently referred to as “BGP routing information.” On the BGP router, the BGP routing information is managed and maintained by an operator who manages the AS to which the BGP router belongs. Conventionally, when a routing failure occurs, the operator makes a check by obtaining information concerning the routing failure from the BGP router through a protocol, called SNMP (Simple Networking Management Protocol), defined by IETF (Internet Engineering Task Force). However, in this case, the operator obtains only information based on MIB (Management Information Base) which is standardized in SNMP. Therefore, in order to investigate causes of the routing failure, the operator needs to access a router, which is considered to be in the condition of the routing failure, and to investigate the causes step-by-step. It should be noted that a notification from a Web user is the only means by which the operator can know of occurrence of the routing failure on a network.

Furthermore, in BGP, path selection is conducted by a so-called Policy-Based Routing, through use of a plurality of attributes (pass attributes). In the Policy-Based Routing, path selection is conducted by an operator based on a policy of each AS. Therefore, there is a case where invalid routing information is transmitted to the BGP router by a human error (miss-configuration). As a result, the user's data may be directed to an invalid path, and a packet may be discarded due to an unknown destination of the packet (which is frequently called a “black hole”). Also, similar situation can result from malicious attacks. A routing failure (invalid routing) due to miss-configuration and/or malicious attacks is called “Route Hijack,” and this is regarded as a problem in BGP routing.

### SUMMARY

Aspects of the present invention are advantageous in that they provide at least one of device, method and computer readable medium for BGP route monitoring which are configured to obtain detailed information concerning which path causes a routing failure and when and why the routing failure occurs, and to prevent, by monitoring of BGP routing information, the device from detecting invalid routing information and from connecting to an invalid path (i.e., Rout Hijack).

According to an aspect of the invention, there is provided a BGP route monitoring device, comprising: a routing information receiving unit configured to receive BGP routing information; a first database storing a plurality of pieces of BGP routing information registered in an IRR server; and a routing failure detecting unit configured to classify the received BGP information into a plurality of states by comparing the received BGP information with the first database and to determine whether the received BGP routing information is invalid based on the classified plurality of states. In this configuration, the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information matches Origin AS number of the BGP routing information in the first database.

With this configuration, it becomes possible to determine whether the received BGP routing information is invalid. In particular, even when the received BGP routing information is determined to be wide routing information made by executing aggregation to decrease the amount of the BGP routing information (i.e., even when PrefixLength of the BGP routing information is shorter than the PrefixLength registered in the IRR server), it is possible to appropriately classify such BGP routing information and to determine whether the BGP routing information is invalid.

In at least one aspect, the routing failure detecting unit may classify the received BGP routing information into eight states. More specifically, the plurality of states classified by the routing failure detecting unit may include: (1) a state where Prefix, PrefixLength and Origin AS number of the received BGP routing information respectively match Prefix, PrefixLength and Origin AS number of the BGP routing information in the first database; (2) a state where Prefix of the received BGP routing information matches Prefix of the BGP routing information in the first database, PrefixLength of the received BGP routing information is longer than PrefixLength of the BGP routing information in the first database, and Origin AS number of the received BGP routing information matches Original AS number of the BGP routing information in the first database; (3) a state where Prefix of the received BGP routing information matches Prefix of the BGP routing information in the first database, PrefixLength of the received BGP routing information is shorter than PrefixLength of the BGP routing information in the first database, and Origin AS number of the received BGP routing information matches Original AS number of the BGP routing information in the first database; (4) a state where Prefix and PrefixLength of the received BGP routing information respectively match Prefix and PrefixLength of the BGP routing information in the first database, and Origin AS number of the received BGP routing information does not match Original AS number of the BGP routing information in the first database; (5) a state where Prefix of the received BGP routing information matches Prefix of the BGP routing information in the first database, PrefixLength of the received BGP routing information is longer than PrefixLength of the BGP routing information in the first database, and Origin AS number of the received BGP routing information does not match Original AS number of the BGP routing information in the first database; (6) a state where Prefix of the received BGP routing information matches Prefix of the BGP routing information in the first database, PrefixLength of the received BGP routing information is shorter than PrefixLength of the BGP routing information in the first database, and Origin AS number of the received BGP routing information does not match Original AS number of the BGP routing information in the first database; (7) a state where Prefix of the received BGP routing information does not match Prefix of the BGP information in the first database; and (8) a state where an inquiry to the first database is running. With this configuration, it becomes possible to make an appropriate determination for all possible paths and conditions on a network.

In at least one aspect, the BGP route monitoring device may further comprise: a filtering unit configured to execute filtering of the BGP routing information based on a determination result by the routing failure detecting unit. In at least one aspect, the filtering unit may execute the filtering at one of a time (1) when the BGP routing information is received by the routing information receiving unit, a time (2) when the BGP routing information is announced to BGP routers on a network, and a time (3) when a best path is selected from among a plurality of pieces of routing information including the BGP routing information. With this configuration, it becomes possible to automatically discard the routing information determined to be an invalid path without the need for operation by an operator. It is also possible to prevent a user from directed to an invalid path and to prevent a packet from being discarded due to an unknown destination.

In at least one aspect, the BGP route monitoring device may further comprise a database updating unit configured to update the first database periodically or in accordance with operation by an operator.

In at least one aspect, the BGP route monitoring device may further comprise: a second database storing the BGP routing information received by the routing information receiving unit; and a backup unit configured to store backup data of the second database at a predetermined timing. In at least one aspect, the backup unit may store a snapshot of memory in the second database into a hard disk. With this configuration, it becomes possible to store all the past data of the second database. Therefore, it becomes possible to obtain detailed information concerning which path causes a routing failure and when and why the routing failure occurs, through an operator's operation for retrieving necessary information from the database or for searching the database.

In at least one aspect, the filtering unit may further execute a plurality of types of actions responsive to the plurality of states. In at least one aspect, wherein the plurality of types of actions include filtering by designation of Prefix and changing of the BGP routing information. With this configuration, it becomes possible to execute a desired filtering on each AS.

In at least one aspect, the routing failure detecting unit may make a determination on whether the received BGP routing information is invalid for all the BGP routing information stored in the second database. With this configuration, it becomes possible to execute reevaluation for a path which is mistakenly determined to be an invalid path depending on, for example, registering timing of the routing information in the IRR server.

According to another aspect of the invention, there is provided a method for BGP route monitoring, comprising: receiving BGP routing information; classifying the received BGP information into a plurality of states by comparing the received BGP information with a first database storing a plurality of pieces of BGP routing information registered in an IRR server; and determining whether the received BGP routing information is invalid based on the classified plurality of states. In this configuration, the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information match Origin AS number of the BGP routing information in the first database.

With this configuration, it becomes possible to determine whether the received BGP routing information is invalid. In particular, even when the received BGP information is determined to be wide routing information made by executing aggregation to decrease the amount of the routing information (i.e., even when PrefixLength of the routing information is shorter than the PrefixLength registered in the IRR server), it is possible to appropriately classify such routing information and to determine whether the routing information is invalid.

According to another aspect of the invention, there is provided a computer readable medium having computer readable instruction stored thereon, which, when executed by a processor of a BGP route monitoring device, configures the processor to perform the steps of: receiving BGP routing information; classifying the received BGP routing information into a plurality of states by comparing the received BGP routing information with a first database storing a plurality of pieces of BGP routing information registered in an IRR server; and determining whether the received BGP routing information is invalid based on the classified plurality of states. In this configuration, the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information match Origin AS number of the BGP routing information in the first database.

With this configuration, it becomes possible to determine whether the received BGP routing information is invalid. In particular, even when the received BGP information is determined to be wide routing information made by executing aggregation to decrease the amount of the BGP routing information (i.e., even when PrefixLength of the BGP routing information is shorter than the PrefixLength registered in the IRR server), it is possible to appropriately classify such BGP routing information and to determine whether the routing information is invalid.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a block diagram illustrating a general configuration of a BGP route monitoring system according to an embodiment of the invention.

FIG. 2 is a block diagram illustrating a general configuration of a BGP router according to an embodiment.

FIG. 3 is a flowchart illustrating a BGP route monitoring process executed on the BGP router according to an embodiment.

FIG. 4 is a flowchart illustrating a routing failure detecting process according to an embodiment.

### DETAILED DESCRIPTION

Hereafter, an embodiment according to the invention will be described with reference to the accompanying drawings.

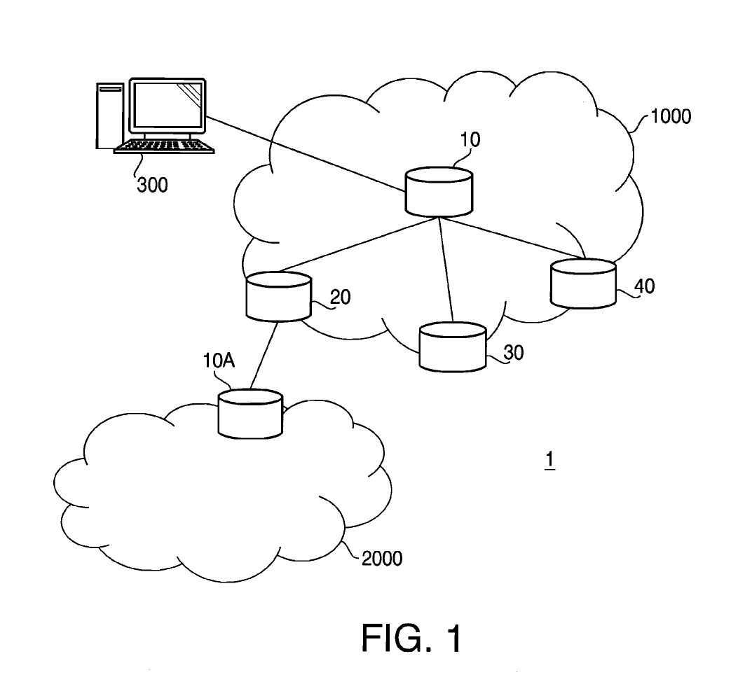

FIG. 1 is a block diagram illustrating a general configuration of a BGP route monitoring system 1 according to the embodiment. The BGP route monitoring system 1 includes an AS 1000 which is an operator's own AS (Autonomous System), an AS 2000 which is an external AS, and an IRP (Internet Routing Registry) server 300. The AS 1000 includes a plurality of BGP routers 10, 20 30 and 40. Each BGP router is a network connection device having a function of connecting the AS 1000 with an external AS (e.g., AS 2000). Furthermore, each BGP router forms a BGP peer through a session of e-BGP (external BGP) with a BGP router (e.g., a BGP router 10A) in the external AS, and exchanges BGP routing information with the external AS.

The BGP router 10 has a route reflector function of collecting the BGP routing information from each of the BGP routers 20, 30, and 40 and reflecting the BGP routing information in each of the BGP routers 20, 30, and 40 by forming a BGP peer with each of the BGP routers 20, 30, and 40 through a session of i-BGP (internal BGP) and by exchanging the BGP routing information with the BGP routers 20, 30, and 40. Hereafter, the BGP router 10 is referred to as a RR (Route Reflector) 10. It should be noted that as a RR 10, a RS (Route Server) having the same route reflector function may be employed. In this embodiment, a backup process and an Anti-Hijack process which are described later are performed on the RR 10 so as to monitor the BGP routing information and reject an invalid (hijacked) path.

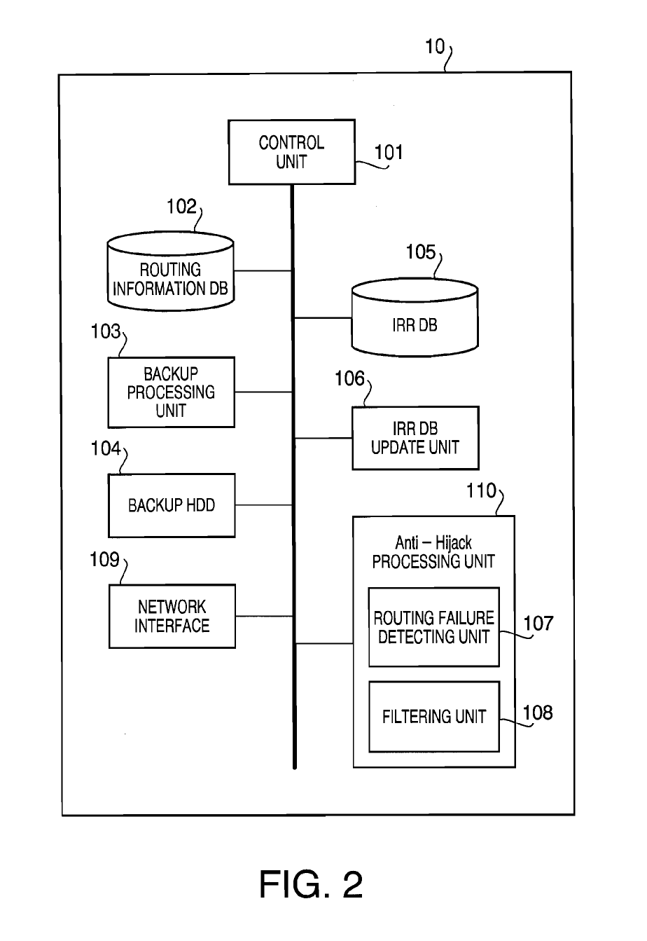

FIG. 2 is a block diagram illustrating a general configuration of the RR 10 according to an embodiment. As shown in FIG. 2, the RR 10 includes a routing information database 102, a backup processing unit 103, a backup HDD (hard disk drive) 104, an IRR database 105, an IRR database update unit 106, an Anti-Hijack processing unit 110 (including a routing failure detecting unit 107 and a filtering unit 108), a network interface 109 and a control unit 101 which totally controls these components in the RR 10. Various processes in the RR 10 may be executed by a CPU (not shown) of the RR 10 by loading and executing programs stored in a memory (e.g., a ROM) in the RR10, or a part of or all of the various processes may be executed by an ASIC (Application Specific Integrated Circuit) provided in the RR 10 as hardware-based processing.

The RR 10 receives the BGP routing information from each BGP router through the network interface 109, and registers the received BGP information in the routing information database 102. Then, the RR 10 announces the BGP routing information to each BGP router. With this configuration, it becomes possible to exchange the BGP routing information between the BGP routers without forming fully-meshed BGP peers between the BGP routers. Furthermore, an operator of each network is able to recognize the current BGP routing information in the network in the BGP route monitoring system 1 by referring to the routing information database 102 of the RR 10.

In this embodiment, not only the current BGP routing information but also the past BGP routing information are stored by the backup processing unit 103 of the RR 10. Specifically, in the backup processing unit 103, data registered in the routing information database 102 is stored periodically in the backup HDD 104. The storing of the data from the routing information database 103 to the backup HDD 104 may be executed at desired timing in response to an operation by the operator or may be executed when the registered information in the routing information database 102 is changed or updated.

In general, it is known that, when past data is backed up in a computer, the data is converted into text data and the converted text data is stored. However, if the text data is stored, the computer needs to convert the text data into an original format in order to analyze the stored text data again. This requires a considerable amount of work. Furthermore, there is a case where the data to be stored is stored in a memory in a scattered state. Therefore, there may be a case where required routing information can not be stored. For this reason, in the backup processing unit 103 according to an embodiment, a snapshot image of data of the routing information database 102 loaded on the memory (RAM) of the RR10 is stored as binary data in the backup HDD 104. With this configuration, when the operator wants to check the one-day-old routing information, the operator is able to read and load again one-day-old binary data of the routing information database 102 on a memory, and thereby to rapidly restore the routing information database 102 to a one-day-old state.

Storing the memory image of the routing information database 102 as it is makes it possible to store all the past data of the routing information database 102. Therefore, it becomes possible to enable the operator to easily recognize where the routing failure (route hijacking) occurs and when and why the routing failure (route hijacking) occurs by obtaining and searching necessary information. Furthermore, even when the routing information database 102 crashes, the RR 10 is able to rapidly restore the routing information database 102 by reading the past memory image, and thereby to continuously execute the function without being noticed by surrounding routers.

Furthermore, the Anti-Hijack processing unit 100 according to the embodiment is configured to detect whether a routing failure (hijacking) occurs on a path by monitoring the BGP routing information through the routing failure detecting unit 107, and to execute filtering through the filtering unit 108 when the abnormal condition occurs. In general, a determination on the route hijack is executed by comparing the BGP routing information registered in an IRR database of an IRR server 300 with received BGP routing information. Specifically, such a determination is executed by comparing Prefix, PrefixLength and an Origin AS number described in an origin attribute of the received BGP routing information with Prefix, PrefixLength and an Origin AS number described in an origin attribute registered in the IRR database of the IRR server 300.

The IRR database of the IRR server 300 is a database storing information concerning the routing information and an administrator (AS number) of the routing information, and the IRR database is released to the public via the Internet. However, an inquiry to the IRR server 300 on the Internet is limited, and therefore it may take a long time to inquire all the routs of the IRR server 300. For this reason, the RR 10 has the IRR database 105 which is a copy of the IRR database opened on the IRR sever 300, so that the received BGP routing information and the BGP routing information in the IRR database 105 can be compared with each other internally on the RR 10. By thus performing internal comparison, it becomes possible to rapidly make a comparison without limitation by the number of counts, and thereby to reduce the traffic on the network. Furthermore, the IRR database 105 is updated by periodically synchronizing with the IRR server 300 through the IRR database update unit 106. Furthermore, in this embodiment, an entry which has obtained once from the IRR database 105 may be stored for a certain time period in a cache. In this case, when the received BGP routing information is checked, first the entry stored in the cache is checked, and then the IRR database 105 is inquired only when the entry is not found in the cache. The RR 10 may be configured to execute a normal BGP process without waiting for a reply from the IRR database 105, and thereafter to make a check on the path when a reply is returned from the IRR database 105.

When the RR 10 makes a comparison between the received BGP routing information received from any of the BGP routers 20, 30, 40, and the BGP routing information of the IRR database 105, three states including “(1) match” (where the received BGP routing information and the BGP routing information in the IRR database 105 match each other), “(2) mismatch” (where the received BGP routing information and the BGP routing information in the IRR database 105 do not match), and “(3) under inquiry” can be considered. In a conventional Anti-Hijack process, when it is determined to be “(2) mismatch” as a result of comparison between the received BGP routing information and the BGP routing information in the IRR database 105, the process determines that the route hijack is detected. However, in actuality, there is a case where a path is notified as more detailed routing information (i.e., routing information having a longer PrefixLength) relative to proper routing information due to, for example, multi-home connections to a provider, or a case where a path is notified as wider routing information (i.e., routing information having a short PrefixLength) by executing aggregation in order to reduce the amount of routing information. In this case, even when a proper path is notified, the BGP routing information registered in the IRR database 105 and the received BGP routing information do not match completely. That is, in the conventional classification in the three states, it is impossible to appropriately determine whether the route is hijacked. For this reason, according to the embodiment, the Anti-Hijack processing unit 110 is configured to classify results of the comparison between the received BGP routing information from a BGP router and the BGP routing information of the IRR database 105 into eight states so that proper determination on the hijack can be made for all possible cases, and suitable actions, such as filtering or passing of the received BGP routing information can be made in response to the classified states.

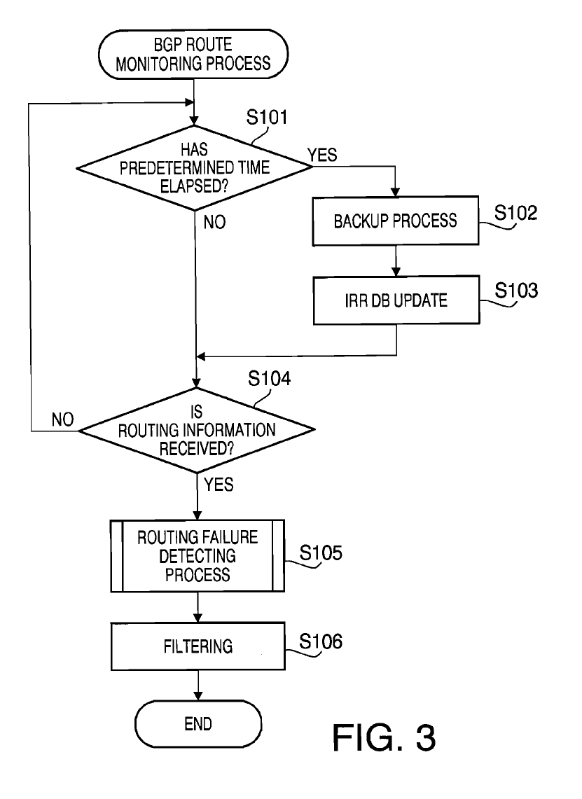

Next, a BGP route monitoring process to be executed on the RR 10 is explained with reference to FIG. 3. First, the control unit 101 determines whether a predetermined time has elapsed (step S101). The predetermined time represents a backup period of the routing information database 102 and an updating period of the IRR database 120, and can be set to a desired value through operation by the operator. When it is determined that the predetermined time has elapsed (S101: YES), the above described backup process for the routing information database 102 is executed by the backup processing unit 103 (step S102). Subsequently, data synchronization with the IRR server 300 is executed by the IRR database update unit 106, and the IRR database 105 is updated (step S103). In this case, backup of the routing information database 102 and update of the IRR database 105 can be executed at different timings.

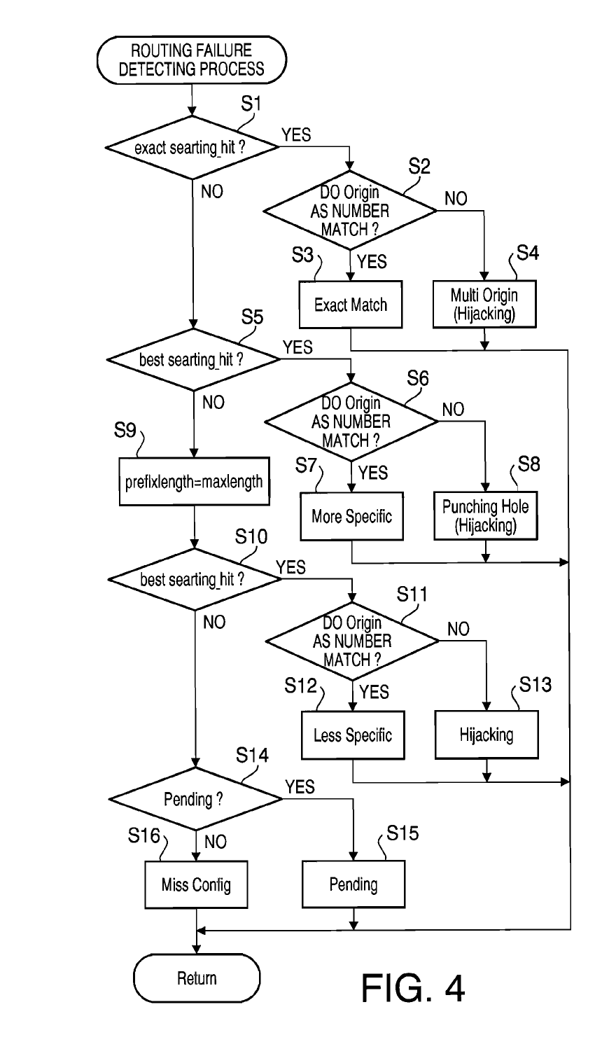

When the predetermined time has not elapsed (S101: NO), control proceeds to step S104 where the RR 10 determines whether the BGP routing information is received from one of the BGP routers. When no BGP routing information is received (S104: NO), control returns to step S101 where the RR 10 determines again whether the predetermined time has elapsed. When the BGP routing information is received (S104: YES), the Anti-Hijack process is executed by the Anti-Hijack processing unit 110 (steps S105 and S106). Specifically, in step S105, a routing failure detecting process is executed to determine whether the received BGP information is invalid. FIG. 4 is a flowchart illustrating the routing failure detecting process according to the embodiment. In this embodiment, results of the comparison between the received BGP routing information and the BGP routing information registered in the IRR database 105 is classified into the following eight states by the routing failure detecting unit 107.
1: Exact Match
2: More Specific
3: Less Specific
4: Multiple Origin (Hijacking)
5: Punching Hole (Hijacking)
6: Miss Config (Hijacking)
7: Hijacking
8: Pending

Specifically, based on Prefix and PrefixLength of the BGP routing information, “exact searching” for the IRR database 105 is performed (step S1). In the exact searching, the BGP routing information in the IPP database 105 having Prefix and PrefixLength both of which are equal to those of the received BGP routing information is searched. For example, regarding Prefix/PrefixLength of “1.1.0.0/16,” it is determined that a hit is found in the exact searching only when the IRR database 105 has the BGP routing information having Prefix/PrefixLength of “1.1.0.0/16.” When a hit is found in the exact searching (S1: YES), the RR 1 determines whether the Origin AS number of the received BGP routing information matches the Origin AS number in the IRR database 105 (step S2). When these Origin AS numbers match with each other (S2: YES), the received BGP routing information is determined to be the “Exact Match” state (step S3). On the other hand, when these Origin AS numbers do not match (S2: NO), the received BGP routing information is determined to be the “Multiple Origin (Hijacking)” state (step S4).

If no hit is found in the exact searching (S1: NO), “best searching” is performed (step S5). In the best searching, the IRR database 105's BGP routing information having Prefix matching with Prefix of the received BGP information and having PrefixLength shorter than that of the received BGP information is searched. For example, if Prefix.PrefixLength of the received BGP routing information is “1.1.0.0/24,” it is determined that a hit is found in the best searching only when the BGP routing information having PrefixLength shorter than “1.1.0.0/24” is found in the IRR database 105. When a hit is found in the best searching (S5: YES), the RR 10 determines whether the Origin AS number of the received BGP routing information matches the AS number of the IRR database 105 (step S6). If these AS numbers match with each other (S6: YES), the path is determined to be “More Specific” state (step S7). On the other hand, when these AS numbers do not match (S6: NO), the path is determined to be “Punching Hole (Hijacking)” state (step S8).

If no hit is found in the best searching (S5: NO), the IRR database 105's BGP routing information having Prefix matching with Prefix of the received BGP information and having PrefixLength longer than that of the received BGP routing information is searched through the best searching. The best searching is configured to search for the BGP routing information in the IRR database 105 having Prefix matching with Prefix of the received BGP information and having PrefixLength shorter than PrefixLength of the received BGP information. For this reason, the PrefixLength of the received BGP information is changed to a maximum value in advance in step S9, and then the best searching is performed again (step S10). For example, if the Prefix/PrefixLength of the received BGP routing information is “1.1.0.0/16,” the PrefixLength is changed to “1.1.1.0/32,” and in this case it is determined that a hit is found in the best searching only when the PrefixLength shorter than “1.1.1.0/32” (e.g., “1.1.0.0/24”) is found in the IRR database 105. As described above, in step S10, the IRR database 105's BGP routing information having Prefix matching with Prefix of the received BGP routing information is searched without regard to PrefixLength of the received BGP routing information. However, for the IRR database 105's routing information having PrefixLength shorter than PrefixLength of the received BGP routing information, a hit has already been found and therefore step S10 is not processed for such IRR database 105′ BGP routing information. Therefore, in actuality, only the IRR database 105′ BGP routing information having PrefixLength longer than PrefixLength of the received BGP routing information is searched in step S10. It should be noted that both of IPv4 and IPv6 can be applied to the present invention. For IPv6, PrefixLength of the received BGP routing information is changed in step S9 to “1.1.1.0/128,” and the routing information having PrefixLength shorter than “1.1.1.0/128” is searched in the best searching in the IRR database 105. When a hit is found in the beast searching (S10: YES), it is determined whether the Origin AS number of the BGP routing information matches the AS number in the IRR database 105 (step S11). When these AS numbers match with each other (S11: YES), the path is determined to be the “Less Specific” state (step S12). On the other hand, when these AS numbers do not match (S11: NO), the path is determined to be “Hijacking” state (step S13).

When no hit is found in the best searching (step S10), the RR 10 determines whether an inquiry to the IRR database 105 is running (step S14). When the inquiry to the IRR database 105 is running (S14: YES), the path is determined to be “Pending” state (step S15). On the other hand, when the inquiry to the IRR database 105 is not running (S14: NO), the path is determined to be “Miss-Config (Miss-configuration/Hijacking)” state.

Table 1 shows classification of the states in the routing failure detecting process shown in FIG. 4.

TABLE 1

| | BGP | IRR | status1 | status2 |
|---|---|---|---|---|
| 1 | /n: i | /n: i | BGP = IRR, i = valid | Exact Match |
| 2 | /n: i | /(n − m): i | BGP > IRR, i = valid | More specific |
| 3 | /n: i | /(n + m): i | BGP < IRR, i = valid | Less specific |
| 4 | /n: i | /n: j | BGP = IRR, i = invalid | Multiple origin |
| | | | | (Hijacking) |
| 5 | /n: i | /(n − m): j | BGP > IRR, i = invalid | Punching hole |
| | | | | (Hijacking) |
| 6 | /n: i | /(n + m): j | BGP < IRR, i = invalid | Hijacking |
| 7 | /n: i | None | BGP not in IRR(with | Miss config |
| | | | recursive lookup) | (Hijacking) |
| 8 | — | — | — | Pending |

/n: Prefix Length
i, j: Origin AS number
m: Integer 0 < m < 32 for IPv4, Integer 0 < m < 128 for IPv6

When the routing failure detecting process show in FIG. 4 is finished, control returns to the BGP route monitoring process shown in FIG. 3. Subsequently, based on the result of the routing failure detecting process, filtering for the BGP routing information is executed through the filtering unit 108 (step S106). In the filtering unit 108, the filtering of the invalid path is performed by setting predetermined actions for the classified eight states, respectively. For example, for “Exact Match,” “More specific,” “Less specific” and “Pending,” the BGP routing information is allowed to pass (and the path is allowed to be registered in routing information database 102), and for “Multiple origin (Hijacking),” “Punching hole (Hijacking),” “Hijacking,” and “Miss Config (Hijacking),” the BGP routing information is filtered (rejected and the path is not allowed or the path is held to be registered in the routing information database 102). Alternatively, for “Multiple origin (Hijacking)” and “Punching hole (Hijacking)”, the BGP routing information may be allowed to pass, or priorities may be assigned to the actions of the states.

As described above, in the RR 10 which is a BGP router, whether the received BGP routing information is invalid is determined, and filtering is performed for the invalid route. Such a configuration makes it possible to reject an invalid path without the need for operations by the operator. Furthermore, by classifying the routing information into the eight states, it becomes possible to execute appropriate filtering for all the possible paths on the networks. Consequently, it becomes possible to avoid an invalid path from being determined to be a proper path, and to avoid a proper path from being determined to be invalid and from being rejected. Furthermore, by setting actions responsive to the states, it becomes possible to execute the filtering having a high degree of freedom in accordance with the policy of each AS.

Although the above embodiments have been described in considerable detail, other embodiments are possible.

Hereafter, variations of the embodiments are explained.

In the above described embodiments, according to other embodiments, the filtering is executed at the time when the BGP routing information is received. However, the filtering may be performed at timings indicated below. For example, the RR 100 may be configured such that the operator is able to select one of the three timings.
Inbound: The filtering is executed when the BGP routing information is input to the RR 10.
Outbound: The filtering is executed when the received BGP routing information is announced to each of the BGP routers 20, 30, and 40.
Best Path Selection: The filtering is performed when the best path is selected from among the plurality of paths.

Furthermore, for Inbound and Outbound, designating Prefix and setting and changing the various types of BGP routing information can be performed as actions to be set for the states in addition to filtering/passing (filtering or passing of the BGP routing information) actions. Specifically, particularly when checking of the route hijack for a certain Prefix is needed, the RR 10 may designate the Prefix and execute the Anti-Hijack process only for the designated Prefix. Furthermore, by designating a BGP peer, the RR 10 may make settings so that the Anti-hijack process is not required for a private peer. Furthermore, by rewriting attributes, such as LOCAL_PREF attribute, contained in the BGP routing information, the BGP routing information may be set so that the BGP routing information can be received as routing information but is not selected as the best path. Thus, by executing the Anti-Hijack process only for the required routing information, increase of the processing speed can be achieved.

Typically, a considerable length of time is needed to execute various procedures until a new IP address is registered in the IRR server 300. Therefore, there is a case where, when the BGP routing information concerning the new IP address is transmitted, the routing information has not been yet registered in the IRR database of the IRR server 300. If the IRR database 105 is updated at the above described timing, the path may be determined to be invalid (Hijacking) and thereby the path is filtered when the Anti-Hijack process according to the embodiment is executed. Furthermore, since the BGP is Hard-State Protocol, the same routing information is not transmitted again unless the routing information is changed. Therefore, when the new BGP routing information is rejected as the invalid path once on the RR 10, the BGP routing information is filtered continuously even after the information is registered in the IRR server 300. Therefore, it is also desirable that the Anti-Hijack process based on the IRR database 105 is executed for all the BGP routing information registered in the routing information database 102 periodically or when the IRR database 105 is updated so that reevaluation for the state of each path can be performed.

It is also possible to register a log indicating that the state of the BGP routing information changes, and to notify the operator of the log. Such a configuration enables the operator to immediately recognize the fact that a routing failure occurs on a path.

Furthermore, for example, the backup process and the routing failure detecting process which are executed on the RR 10 in the above described embodiment may be executed on a terminal device (e.g. a PC) connected to the BGP router for remote controlling. In this case, by proving a function as a BGP passive speaker for the terminal device, the terminal device is able to obtain the routing information in the RR 10. Furthermore, the terminal device may be provided with the components provided in the RR 10 excepting the filtering unit 108 so that the terminal device is able to execute the baking up process and the routing failure detecting process. In this case, when an invalid path is detected by the routing failure detecting unit 107, it is possible to notify the operator of the routing failure condition and/or to enable the operator to remotely control the RR 10 to execute various actions (filtering) based on the classified eight states. With this configuration, it becomes possible to reduce the processing load placed on the RR 10 and thereby to achieve the above described functions by using existing BGP routers.

What is claimed is:

1. A BGP route monitoring device, comprising:
a routing information receiving unit configured to receive BGP routing information;
a first database for storing a plurality of pieces of BGP routing information registered in an IRR server; and
a routing failure detecting unit configured to classify the received BGP information into a plurality of states by comparing the received BGP information with the first database, and to determine whether the received BGP routing information is an invalid path based on the classified plurality of states,
wherein the plurality of states include a state where Prefix of the received BGP information matches Prefix of BGP routing information in the first database, PrefixLength of the received BGP information is shorter than PrefixLength of the BGP routing information in the first database, and Origin AS number of the received BGP routing information matches Origin AS number of the BGP routing information in the first database.

2. The BGP route monitoring device according to claim 1, wherein the routing failure detecting unit is configured to classify the received BGP routing information into eight states.

3. The BGP route monitoring device according to claim 1, further comprising a filtering unit configured to execute filtering of the BGP routing information based on a determination result by the routing failure detecting unit.

4. The BGP route monitoring device according to claim 1, further comprising a database updating unit configured to update the first database periodically or in accordance with designation by an operator.

5. The BGP route monitoring device according to claim 1,
further comprising:
a second database for storing the BGP routing information received by the routing information receiving unit; and
a backup unit configured to store backup data of the second database at a predetermined timing.

6. The BGP route monitoring device according to claim 5, wherein the backup unit is configured to store a snapshot of memory in the second database into a hard disk.

7. The BGP route monitoring device according to claim 1,
wherein the filtering unit is configured to execute the filtering at one of a time (1) when the BGP routing information is received by the routing information receiving unit, a time (2) when the BGP routing information is announced to BGP routers on a network, and a time (3) when a best path is selected from among a plurality of pieces of routing information including the BGP routing information.

8. The BGP route monitoring device according to claim 1,
wherein the plurality of states classified by the routing failure detecting unit comprise:
(1) a state where Prefix, PrefixLength and Origin AS number of the received BGP routing information respectively match Prefix, PrefixLength and Origin AS number of the BGP routing information in the first database;
(2) a state where Prefix of the received BGP routing information matches Prefix of the BGP routing information in the first database, PrefixLength of the received BGP routing information is longer than PrefixLength of the BGP routing information in the first database, and Origin AS number of the received BGP routing information matches Original AS number of the BGP routing information in the first database;
(3) a state where Prefix of the received BGP routing information matches Prefix of the BGP routing information in the first database, PrefixLength of the received BGP routing information is shorter than PrefixLength of the BGP routing information in the first database, and Origin AS number of the received BGP routing information matches Original AS number of the BGP routing information in the first database;
(4) a state where Prefix and PrefixLength of the received BGP routing information respectively match Prefix and PrefixLength of the BGP routing information in the first database, and Origin AS number of the received BGP routing information does not match Original AS number of the BGP routing information in the first database;
(5) a state where Prefix of the received BGP routing information matches Prefix of the BGP routing information in the first database, PrefixLength of the received BGP routing information is longer than PrefixLength of the BGP routing information in the first database, and Origin AS number of the received BGP routing information does not match Original AS number of the BGP routing information in the first database;
(6) a state where Prefix of the received BGP routing information matches Prefix of the BGP routing information in the first database, PrefixLength of the received BGP routing information is shorter than PrefixLength of the BGP routing information in the first database, and Origin AS number of the received BGP routing information does not match Original AS number of the BGP routing information in the first database;
(7) a state where Prefix of the received BGP routing information does not match Prefix of the BGP information in the first database; and
(8) a state where an inquiry to the first database is running.

9. The BGP route monitoring device according to claim 1, wherein the filtering unit is further configured to execute a plurality of types of actions responsive to the plurality of states.

10. The BGP route monitoring device according to claim 9, wherein the plurality of types of actions comprise filtering by designating Prefix and changing the BGP routing information.

11. The BGP route monitoring device according to claim 5, wherein the routing failure detecting unit is configured to make a determination on whether the received BGP routing information is an invalid path for all the BGP routing information stored in the second database.

12. A computer implemented method for BGP route monitoring the method, comprising:
receiving BGP routing information;
classifying the received BGP information into a plurality of states by comparing the received BGP information with a first database storing a plurality of pieces of BGP routing information registered in an IRR server; and
determining whether the received BGP routing information is an invalid path based on the classified plurality of states,
wherein the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information match Origin AS number of the BGP routing information in the first database.

13. A nontransitory computer readable medium having computer readable instruction stored thereon, which, when executed by a processor of a BGP route monitoring device, configures the processor to perform the steps of:
receiving BGP routing information;
classifying the received BGP information into a plurality of states by comparing the received BGP information with a first database storing a plurality of pieces of BGP routing information registered in an IRR server; and
determining whether the received BGP routing information is an invalid path based on the classified plurality of states,
wherein the plurality of states include a state where Prefix of the received BGP information matches Prefix of BGP routing information in the first database, the PrefixLength of the received BGP information is shorter than PrefixLength of the BGP routing information in the first database, and Origin AS number of the received BGP routing information match Origin AS number of the BGP routing information in the first database.
